(19) United States
(12) Patent Application Publication
(10) Pub. No.: US 2026/0085924 A1
(43) Pub. Date: Mar. 26, 2026

(54) MEASURING STOCKPILES

(71) Applicant: Innomotics GmbH, 90441 Nürnberg (DE)

(72) Inventor: MICHAEL ROSSBERG, Leipzig (DE)

(73) Assignee: Innomotics GMBH, 90441 Nürnberg (DE)

(21) Appl. No.: 19/111,698

(22) PCT Filed: Sep. 22, 2023
(86) PCT No.: PCT/EP2023/076192

§ 371 Date: Mar. 13, 2025

(30) Foreign Application Priority Data
Sep. 30, 2022 (EP) 22199132.6

(51) Int. Cl. G01B 11/00

(52) U.S. Cl. CPC G01B 11/00; G01B 2210/54

(57) ABSTRACT

In a method for measuring a stockpile, a scanner detects a reference point of a reference body. A scanner position and a scanner alignment for the scanner is ascertained using the detected reference point. Scan data of the stockpile is detected by the scanner and a position and volume of the stockpile is ascertained using the scan data.

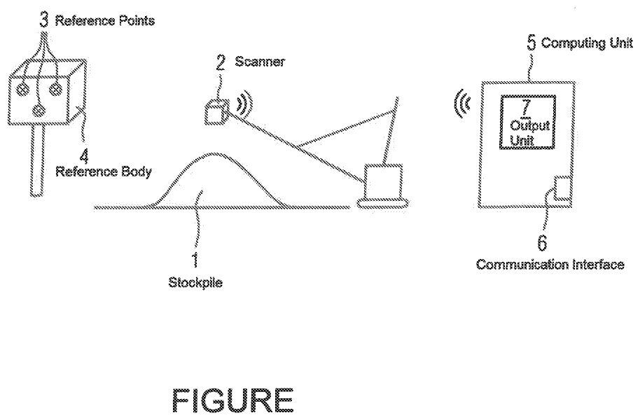

The invention relates to a method, a measuring system, a computer program and a computer program product for measuring stockpiles.

Measurements of stockpiles can be used in particular in the field of mining but also for instance when loading and/or unloading ships, for instance. In order to measure bodies, such as for instance a (bulk material) stockpile, the (mounting) position and alignment of the scanner must essentially be known precisely. To this end, drone systems are also known by now, which ascertain their position by way of GPS.

With terrestrial systems, the current process for determining the position and alignment of a scanner typically provides the following:
1. Determination of the scanner position by gauger or by hand,
2. Determination of the alignment of the scanner,
3a. Mounting an inclinometer or
3b. Recording scan data, manual calculation of the scanner alignment and renewed recording of scan data for verifying the calculated parameters.

The object underlying the invention is to improve the measurement of stockpiles in comparison to the prior art.

This object is achieved by a method for measuring a stockpile, wherein at least one scanner detects at least one reference point of at least one reference body, wherein at least one scanner position and a scanner alignment are ascertained for the at least one scanner using the at least one detected reference point, wherein scan data of the stockpile is detected by the at least one scanner and wherein at least the position and the volume of the stockpile are ascertained using the scan data.

The object is further achieved by a measuring system for measuring a stockpile, comprising at least one computing unit, at least one scanner and at least one reference body, which has at least one reference point, wherein at least one reference point can be detected by at least one scanner, wherein at least one scanner position and a scanner alignment can be ascertained for the at least one scanner in the computing unit using the at least one reference point, wherein scan data of the stockpile can be detected by the at least one scanner and wherein at least the position and the volume of the stockpile can be ascertained in the computing unit using the scan data.

The object is further achieved by a computer program and a computer program product having the features specified in claims 11 and 12.

The position of characteristic (reference) points of the reference body in the room is known by means of a measurement with simple auxiliary means. Existing reference bodies (wall, etc.) or reference bodies (cubes with adequate size, etc.) which are installed as extra and measured by the scanner can be used. An item of software then ascertains the position and the alignment of the scanner by means of calculations. This information can subsequently be used to measure the position and the volume of the stockpile very accurately. It is clear that, for this purpose, depending on the visibility of the stockpile from the respective scanner position or positions, several scanners and/or reference bodies can also be used. The existing possibilities naturally always depend on the respective use in individual cases. Thus, as a function of the bulk material, e.g. an increased development of dust may result in a per se well suited scanner position at the end of a stacker being replaced by possibly two scanners positioned to the side of the stockpile.

With the inventive solution, the scanner position can be ascertained without requiring a gauger with the aid of software. As a result, the scanner position determination becomes easier and more cost-effective. The alignment of the scanner can likewise be ascertained in a significantly simpler and more rapid manner with the aid of software. The expensive and error-prone manual calculation is omitted, and as a result significantly less know-how is required during its execution.

In an advantageous form of the embodiment, a 2D or 3D laser scanner is used as at least one scanner. Different types of scanners are naturally conceivable (optical, acoustic . . . ), but these laser scanners have by now become established and are also available at a reasonable price at high quality.

In a further advantageous embodiment, at least the position and the volume of the stockpile are transferred to a higher-level control system. In this way, the control system, which controls a stacker, for instance, is informed about the size and thus possibly the remaining capacity of the stockpile and can operate accordingly.

In a further advantageous embodiment, a profile of the stockpile is visualized on the basis of the position and the volume. In this way, it is easier for a human operator to detect the situation.

In a further advantageous embodiment, the steps of detecting the scan data and of ascertaining the position and the volume of the stockpile are executed repeatedly, With a correspondingly high “frequency” of the repetition, the stockpile can to some extent be monitored almost in real-time.

In a further advantageous embodiment, the steps of detecting at least one reference point and determining the scanner position and the scanner alignment are executed repeatedly. In this way, the scanner position and scanner alignment can be recalibrated at least every now and again, particularly when scanners are not fully stationary (like with mounting points on stackers, baggers etc.) so that the accuracy of the stockpile measurement can be kept constant.

The invention is described and explained in more detail below using the exemplary embodiment shown in the FIGURE.

The FIGURE shows a schematic representation of a stockpile 1, on which bulk materials are unloaded by way of a stacker. A scanner 2 for measuring the stockpile 1 is arranged at the end of the stacker. In order to calibrate the scanner 2, i.e. to ascertain the scanner position and the scanner alignment, reference points 3 are detected on a reference body 4 and the scanner position and the scanner alignment are ascertained therefrom with the aid of a program, which runs in a computing unit 5 of the measuring system, which comprises at least the computing unit 5, the scanner 2 and the reference body 4. The scanner 2 which is advantageously embodied as a 2D or 3D laser scanner subsequently scans the stockpile 1 and transfers the scan data for ascertaining the position and the volume of the stockpile 1 to the computing unit 5. This can occur for instance, as shown in the FIGURE, by way of a wireless data link. The position and the volume of the stockpile 1 can be transferred to a higher-level control system by the computing unit 5 preferably also by way of a suitable communication interface 6. The computing unit 5 can either be executed in a mobile manner or integrated into another system, for instance into a controller of the stacker. A profile of the stockpile 1 can advantageously also be visualized in an output unit 7 of the computing unit 5, which makes it easier for an operator of the stacker to detect the situation.

In summary, the invention relates to a method, a measuring system, a computer program and a computer program product for measuring stockpiles. In order to improve the measurement of the stockpiles by comparison with the prior art, a method for measuring a stockpile is proposed, wherein at least one scanner detects at least one reference point of at least one reference body, wherein at least one scanner position and a scanner alignment are ascertained for the at least one scanner on the basis of the at least one detected reference point, wherein scan data of the stockpile is detected by the at least one scanner and wherein at least the position and the volume of the stockpile are ascertained using the scan data. The object is further achieved by a measuring system for measuring a stockpile, comprising at least one computing unit, at least one scanner and at least one reference body, which has at least one reference point, wherein at least one reference point can be detected by at least one scanner, wherein at least one scanner position and a scanner alignment can be ascertained using the at least one reference point for the at least one scanner in the computing unit, wherein scan data of the stockpile can be detected by the at least one scanner and wherein at least the position and the volume of the stockpile can be ascertained in the computing unit using the scan data. With the inventive solution, the scanner position and the scanner alignment can be ascertained with the aid of software without requiring a gauger. The measurement of the stockpile becomes easier and more cost-effective as a result.

1.-12. (canceled)

13. A method for measuring a stockpile, the method comprising:
detecting with a scanner a reference point of a reference body;
ascertaining a scanner position and a scanner alignment for the scanner using the detected reference point;
detecting scan data of the stockpile by the scanner; and
ascertaining a position and volume of the stockpile using the scan data.

14. The method of claim 13, wherein the scanner is a 2D or 3D laser scanner.

15. The method of claim 13, further comprising transferring the position and the volume of the stockpile to a higher-level control system.

16. The method of claim 13, further comprising visualizing a profile of the stockpile using the position and the volume.

17. The method of claim 13, wherein detecting the scan data and ascertaining the position and the volume of the stockpile are executed repeatedly.

18. The method of claim 13, wherein detecting the reference point and ascertaining the scanner position and the scanner alignment are carried out repeatedly.

19. A measuring system for measuring a stockpile, the measuring system comprising:
a reference body having a reference point;
a scanner designed to detect the reference point and to detect scan data of the stockpile; and
a computing unit designed to ascertain a scanner position and a scanner alignment for the scanner using the reference point and to ascertain a position and the volume of a stockpile using the scan data;

20. The measuring system of claim 19, wherein the scanner is designed as a 2D or 3D laser scanner.

21. The measuring system of claim 19, further comprising:
a higher-level control system; and
a communication interface via which the position and the volume of the stockpile is transferred to the higher-level control system.

22. The measuring system of claim 19, further comprising an output unit designed to visualize a profile of the stockpile using the position and the volume of the stockpile.

23. A computer program embodied in a non-transitory computer readable medium, wherein the computer program, when loaded into computing unit of a measuring system and executed by the computing unit causes the computing unit to perform the steps of:
detecting with a scanner of the measuring system a reference point of a reference body;
ascertaining a scanner position and a scanner alignment for the scanner using the detected reference point;
detecting scan data of the stockpile by the scanner; and
ascertaining a position and volume of the stockpile using the scan data.

24. A computer program product, comprising the computer program of claim 23.
